(19) United States
(12) Patent Application Publication
(10) Pub. No.: US 2004/0264974 A1
(43) Pub. Date: Dec. 30, 2004

(54) Cable television passive optical network

(76) Inventor: Donald C. Sorenson, Denver, CO (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 10/862,733

(22) Filed: Jun. 7, 2004

Related U.S. Application Data
(60) Provisional application No. 60/476,819, filed on Jun. 6, 2003.

(51) Int. Cl. H04B 10/00

(52) U.S. Cl. 398/140

(57) ABSTRACT

A baseband burst mode optical transmitter for receiving reverse electrical signals and for providing a reverse optical signal. The baseband burst mode optical transmitter includes an analog-to-digital converter and a framer/encoder circuit for adding a synchronization word and a start-of-data word to the reverse digital signals. Additionally, a carrier detect circuit is included for detecting the presence of a carrier signal included in the reverse electrical signals, whereby when the carrier detect circuit detects the presence of the carrier signal, the optical transmitter transmits optical signals (i.e., optical signals are only transmitted if the reverse electrical signals include the carrier signal). A baseband burst mode optical receiver receives the optical signals and strips the synchronization word and start-of-data word from the digital signals and then converts the signals back to analog signals.

### RELATED APPLICATIONS

This application claims priority to U.S. provisional application Ser. No. 60/476,819 entitled Cable Television Passive Optical Network filed Jun. 6, 2003, the teachings of which are hereby incorporated in its entirety by reference.

### FIELD OF THE INVENTION

This invention relates generally to broadband communications systems, such as cable television systems, and more specifically to baseband burst-mode digital transmitters and receivers used in a passive optical network of the broadband communications system.

### BACKGROUND OF THE INVENTION

A broadband communications system, such as a two-way hybrid fiber/coaxial (HFC) system is used for transmitting video/audio, voice, and data signals. The communications system includes headend equipment for generating forward signals that are transmitted in the forward, or downstream, direction along fiber or coaxial cable depending upon the application. Conventionally, an analog communications system transmits and receives the forward and reverse signal in the analog domain. More recently, the broadband communications systems, such as a cable television network, are migrating towards passive optical networks from the analog HFC network. Accordingly, higher cost analog optical transmitters and receivers are required throughout the system. Additionally, operators continue to utilize existing HFC networks and upgrade when desired or necessary. Therefore, there is a need for systems and methods that optically transmit upstream analog signals from a premises device while still supporting standard analog-based HFC applications and lowering the costs of the analog optical transmitters.

### BRIEF DESCRIPTION OF THE DRAWINGS

FIG. 1 is a block diagram of a passive optical network in accordance with the present invention.

FIG. 2 is a block diagram of a burst mode digital transmitter.

FIG. 3 is a block diagram of a baseband burst mode digital transmitter in accordance with the present invention that is suitable for use within the passive optical network of FIG. 1.

FIG. 4 is an illustration of a cable television passive optical network frame format that is the output of the baseband burst mode digital transmitter of FIG. 3.

FIG. 5 is a block diagram of a baseband burst mode digital receiver in accordance with the present invention that is suitable for use within the passive optical network of FIG. 1.

### DETAILED DESCRIPTION OF A PREFERRED EMBODIMENT

Preferred embodiments of the invention can be understood in the context of a fiber to the premise (FTTP) broadband communications system. Note, however, that the invention may be embodied in many different forms and should not be construed as limited to the embodiments set forth herein. For example, the network illustrated herein is a bus-star passive optical network (PON) topology; however, the present invention can be used in other topologies. Additionally the FTTP system can also be a fiber to the business (FTTB) system. All examples given herein, therefore, are intended to be non-limiting and are provided in order to help clarify the description of the invention.

The present invention is directed towards a baseband burst-mode digital transmitter (B²MDT) and a baseband burst-mode digital receiver (B²MDR). In accordance with the present invention, the B²MDT and B²MDR combination allow a novel means of transporting digitized reverse path data via a PON. The low cost B²MDT, which is located at a subscriber's premises, digitizes the reverse path data in accordance with the present invention, and the B²MDR translates the reverse path data back into its native radio frequency (RF) format.

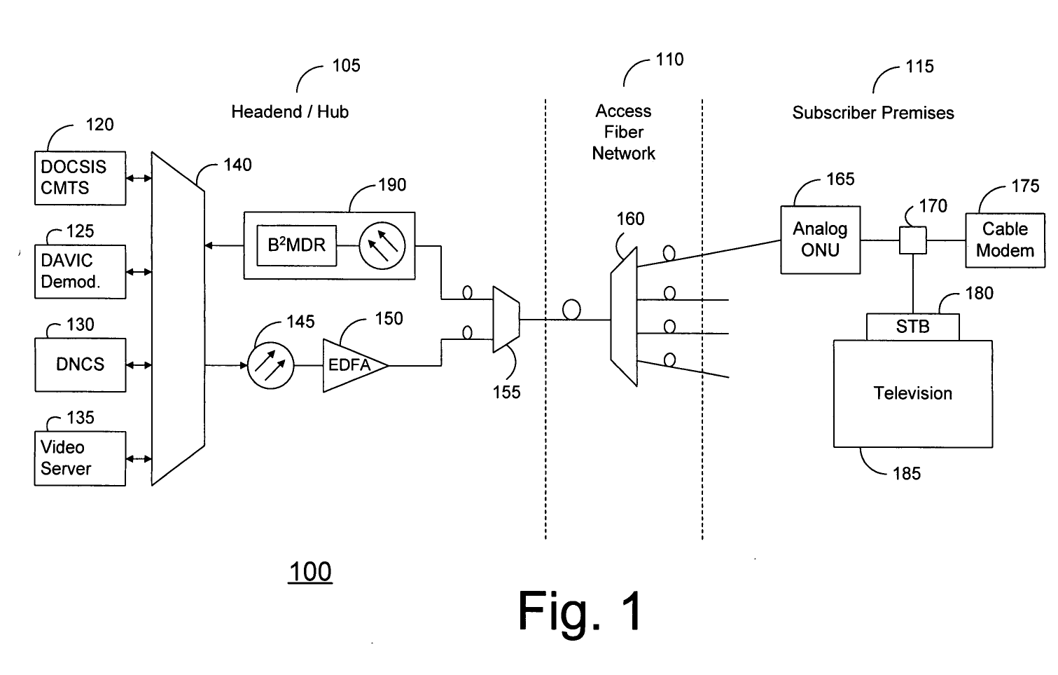

FIG. 1 is a block diagram of a passive optical network (PON) 100 in accordance with the present invention. The PON 100 includes a headend or hub section 105, an access fiber network 110, and a plurality of subscriber premises 115. The PON 100 transmits and receives high-speed data, video, and voice signals in a standard cable television format in the downstream direction and in a digitized format in the upstream direction. As known in the art, the signals are transmitted to the subscriber premises 115 using standard media access control (MAC) functions. The headend or hub 105 may include at least a DOCSIS CMTS 120, a DAVIC demodulator 125, a DNCS 130, and a video server 135 to name but a few, for conventional signal processing. The signals are routed via a multiplexer/demultiplexer 140. Further information regarding a PON can be found in commonly assigned U.S. patent application Ser. No. 6,714,598, filed Apr. 29, 2002, the teachings of which are hereby incorporated by reference.

In the forward, or downstream, direction, forward signals are provided to a laser 145 and amplifier 150, such as an EDFA, to provide an amplified optical signal. A combiner 155 provides the signals to the access fiber network 110 for delivery to the plurality of subscriber premises 115. It will be appreciated that the forward signals can be broadcast signals or targeted signals depending upon the application. Separated signals provided by a splitter 160 are transmitted to at least one analog optical network unit (ONU) 165. The analog ONUs represent the premises device and may be located at a subscriber's home or business. As illustrated, the analog ONU 165 provides RF signals to a splitter 170 that routes cable modem signals to a cable modem 175 and video/voice signals to a set-top box (STB) 180 for viewing on a television 185, for example.

In the reverse, or upstream, direction, the radio frequency (RF) signals are digitized and formatted in accordance with the present invention using a burst-mode digital technique in an upstream transmitter. The reverse signals are subsequently provided upstream through the access fiber network 110 to a B²MDR. The B²MDR converts the subscriber's digitized, formatted signals back into an analog format at the headend/hub 105 for RF processing using standard hybrid fiber/coax (HFC) application systems. Through this process, the present invention enables the use of at least one three (3) or six (6) Mega Hertz (MHz) wide upstream DOCSIS channel plus an optional DAVIC digital television STB upstream signal in the event an STB does not support DOCSIS as a return path protocol. For example, using DOCSIS 2.0, the present invention affords the delivery of a standard 870 MHz broadcast video payload, VoIP (Voice over Internet protocol) voice and high-speed data services with upstream data rates at 30 Mb/s. A cable television PON's physical range with a 32-way splitter 160 is approximately 7 to 10 kilometers (km). It will be appreciated that longer ranges can be achieved with lower PON split ratios.

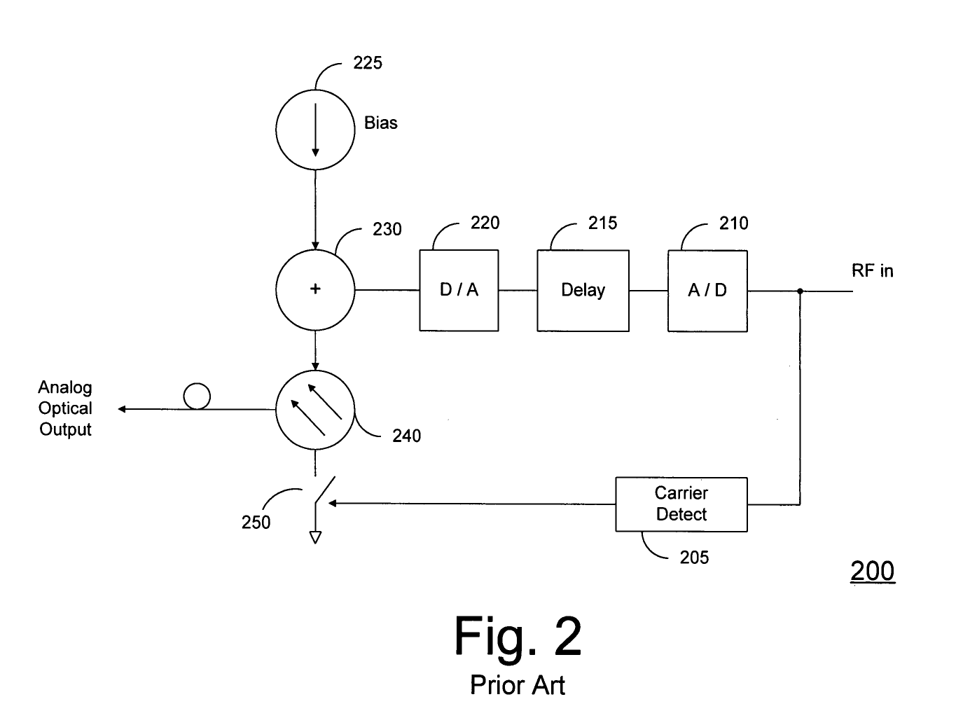

FIG. 2 is a block diagram of a burst mode digital transmitter 200. From the plurality of subscriber premises 115, the transmitter 200 only transmits reverse signals when the presence of a carrier is detected. Accordingly, a carrier detect circuit 205 monitors the received reverse signals. Concurrently, an analog-to-digital (A/D) device 210 converts the reverse analog signal to a digital signal. A delay device 215 delays the digital signal for an appropriate amount of time in order to allow the carrier detect circuit 205 to determine whether or not the reverse signals include a carrier signal. The delayed digital signals are then provided to a digital-to-analog (D/A) device 220 for conversion back to analog signals. An adder circuit 230 combines a current from a bias circuit 225 and the analog signals and provides the combined signal to a laser 240 for conversion to an optical signal. If the carrier detect circuit 205 detected a carrier signal, the carrier detect circuit 205 controls switch 250, which then allows the optical signal to be provided upstream. Further information regarding the burst mode digital transmitter and receiver can be found in commonly assigned U.S. Pat. No. 6,509,994 filed Apr. 23, 2001.

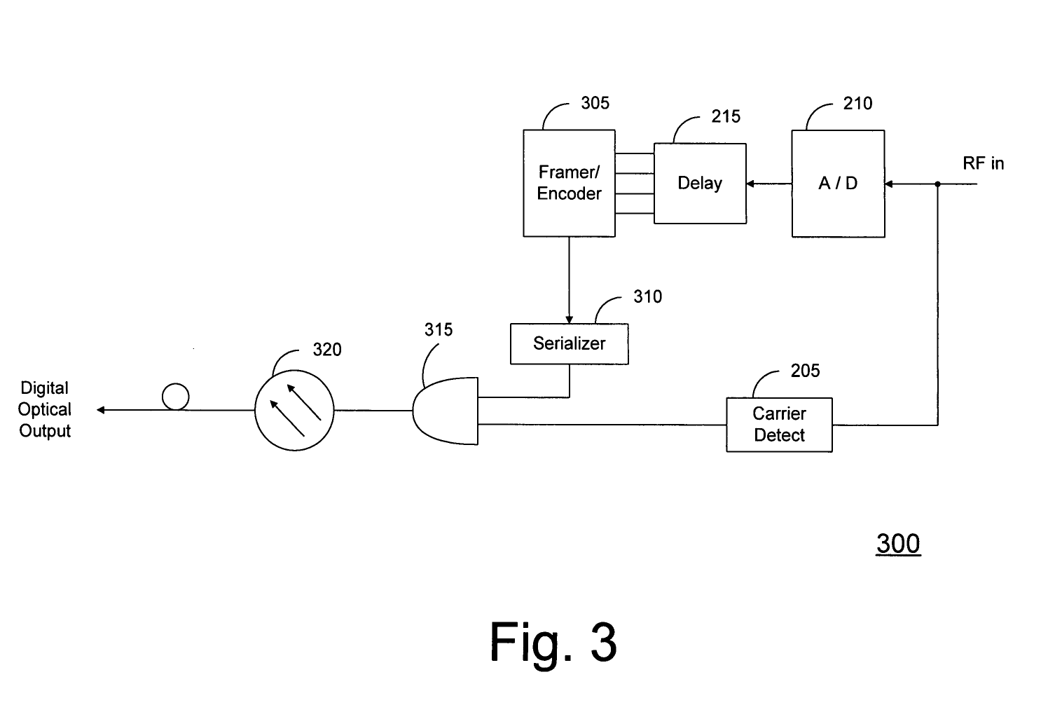

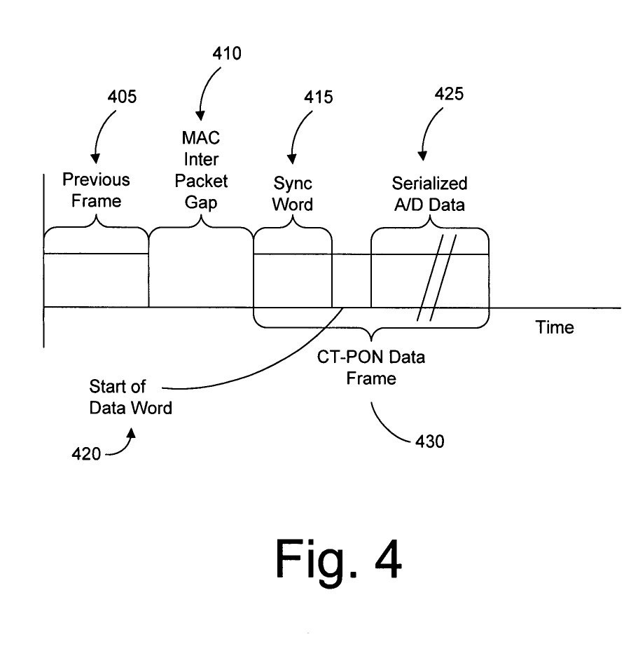

FIG. 3 is a block diagram of a baseband burst mode digital transmitter (B²MDT) in accordance with the present invention that is suitable for use within the passive optical network of FIG. 1. The B²MDT 300 is an improved transmitter, which replaces the burst mode digital transmitter. Similarly, the B²MDT includes the carrier detect circuit 205, the analog-to-digital transmitter 210, and the delay circuit 215. The delayed digital signal, however, is subsequently provided to a framer/encoder circuit 305. The framer/encoder circuit 305 appends a synchronization word sequence and a start-of-data word to the beginning of each B²MDT transmission. FIG. 4 is an illustration of a cable television passive optical network frame format that is the output of the baseband burst mode digital transmitter of FIG. 3. FIG. 4 shows a previous frame 405 that was previously transmitted and a MAC inter-packet gap (IPG) 410. The IPG is induced and controlled by the host application to ensure that data frames being transmitted by multiple subscriber terminal devices do not overlap or interfere with each other. Thus the IPG 410 is always present, however, its time duration is a function of the host application MAC protocol. The synchronization word 415 is selected to produce a bit pattern that facilitates proper transmitter to receiver synchronization. The synchronization word 415 is composed of a series of alternating ones and zeros, accordingly the B2MDR utilizes the pattern to synchronize its own internal clock to accurately detect the upcoming serialized data frame. Also, the synchronization word 415 terminates by a start-of-data word 420 that is used by the receiver to byte align the incoming data. More specifically, the start-of-data word 420 signals the beginning of A/D data thereby ensuring proper byte alignment between the B²MDT A/D and the B²MDR D/A. Following is the serialized digitized data 425. Therefore, the CT-PON data frame 430 is a series of A/D converted data words that continues until the RF carrier signal is no longer detected at the input of the carrier detect circuit 205. No limit is placed on the length of the data portion of the frame 430. The framer/encoder 305 does not append any form of addressing, checksum, or other customary access control data since access control and error correction is performed at a higher level by the application MAC process.

Referring again to FIG. 3, the encoder portion of the frame/encoder 305 performs a line-encoding function on the A/D signals to facilitate reliable data recovery at the B²MDR. The type of line encoding performed is a 4b/5b block type used in many other serialized baseband data links such as 100 Mb Ethernet. The 4b/5b block encoding ensures that the data stream spectrum is always suitably spread ensure accurate receiver side clock synchronization regardless of the A/D data values. The 4b/5b block encoding scheme entails a 25% bandwidth overhead; however, since the subscriber data is already RF encoded, this overhead component does not reduce the bandwidth available to the subscriber in the upstream link.

A serializer 310 converts the encoded data into a 1-bit wide serial format compatible with laser drive circuitry. The serial data rate is determined by multiplying the A/D clocking rate by the A/D's word size, in bits, times encoding overhead of 5 divided by 4. For example, a 6 bit A/D clocked at 20 MHz yields a 150 Mbps serial data rate at the output of the serializer. The serialized data is then gated at gate 315 depending on whether or not the carrier detect circuit 205 has detected the presence of a carrier signal. If a carrier signal was detected, the serialized data is provided to laser 320 for conversion into optical signals for further transmission to the B²MDR located in the headend/hub 105.

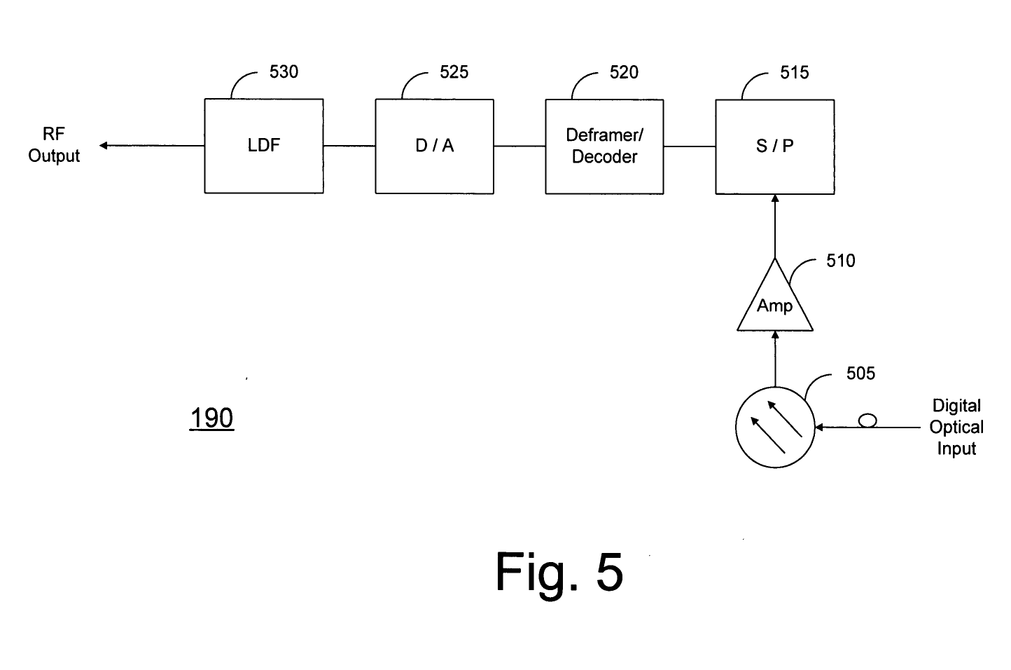

FIG. 5 is a block diagram of the baseband burst mode digital receiver (B²MDR) 190 in accordance with the present invention that is suitable for use within the passive optical network of FIG. 1. The receiver 190 receives up to 32 B²MDTs that are attached to the PON fiber network 100. An incoming laser detector 505 receives the reverse optical signals and converts them to RF signals. An amplifier 510 then amplifies the signals. A serial-to-parallel (S/P) device 515 converts the serial signals into parallel signals prior to providing them to a deframer/decoder device 520. The S/P device 515 also synchronizes the receiver's internal clock to the incoming data frame. For each frame, synchronization is initially established by locking to the frame's synchronization word 415. Maintenance of the synchronization lock is then facilitated by the incoming data's 4b/5b block coding. The S/P converter multiplexes the serial data into multi-bit words that are clocked into the decoder/deframer device 520.

The decoder function extracts the original A/D data from the 4b/5b encoding. The synchronization word 415 and the start of data word 420 are stripped from the frame and the data is clocked into a D/A converter 525. The deframer is reset between data frames by the loss of carrier that occurs during the inter-packet gap 410. The D/A converter clock rate is related to the incoming data rate by the block encoding efficiency and A/D converter bit size. A low pass filter (LPF) 530 then yields the original B²MDT RF input signal.

In summary, the present invention demonstrates systems and methods for remotely locating the B²MDT D/A function such that the overall burst mode digital transmission can be implemented over a shared fiber passive optical network. The present invention results in the elimination of complex time division multiple access (TDMA) functionality at either the subscriber premise 115 or the headend/hub 105 that is typically required to implement comparable upstream networking functionality.

What is claimed is:

1. A method for transmitting a reverse signal having a carrier signal, the method comprising the steps of:
receiving the reverse signal at a transmitter;
detecting the presence of a carrier signal included in the reverse signal;
digitizing the reverse signal;
framing and encoding the reverse signal to provide a data frame having a synchronization word and a start-of-data word;
serializing the data frame; and
converting the serialized data frame into an optical signal, wherein the optical signal is transmitted in the event that the presence of a carrier signal is detected, and wherein the optical signal is dropped in the event that the presence of a carrier signal is not detected.

2. The method of claim 1, wherein a receiver receives the optical signal and provides an analog signal.

3. The method of claim 2, further comprising the steps of:
at the receiver, detecting the optical signals and providing an RF signal;
converting the serial RF signal into a parallel RF signal;
deframing and decoding the parallel RF signal using the synchronization word and the start of data word; and
converting the digital RF signal into an analog signal.

4. An optical transmitter for receiving electrical signals and for providing optical signals in a passive optical network, the optical transmitter comprising:
an analog-to-digital (A/D) converter coupled to an input of the optical transmitter for converting the electrical signals to digital signals;
a delay circuit coupled to the A/D converter for delaying the digital signals;
a framer/encoder circuit for providing a data frame including the digital signals, a synchronization word, and a start-of-data word;
a serializer for providing a serialized data frame;
a carrier detect circuit coupled to the A/D converter for detecting the presence of a carrier signal included within the electrical signals;
a switching means responsive to the carrier detect circuit; and
a laser coupled to the switching means for converting the serialized data frame into an optical signal,
wherein the carrier detect provides the switching means with a first signal allowing the transmission of the data frame to the laser when the presence of a carrier signal is detected, and wherein the carrier detect provides the switching means a second signal that prevents the transmission of the data frame.

5. The optical transmitter of claim 4, wherein the delay circuit delays the digital signals by a predetermined period of time.

6. The optical transmitter of claim 4, wherein the passive optical network comprises:
an optical receiver for receiving the optical signal and providing an RF analog signal.

7. The optical transmitter of claim 4, wherein the optical receiver comprises:
a laser detector for receiving the optical signal and providing an electrical signal;
a serial-to-parallel circuit for providing a serial electrical signal;
a deframer/decoder circuit for stripping the synchronization word and the start-of-data word from the data frame; and
a digital-to-analog (D/A) converter for converting the data frame back into an analog signal.

8. A passive optical network (PON) for transmitting optical signals, the PON comprising:
an optical transmitter for receiving analog electrical signals and providing digital optical signals, wherein the digital optical signals comprise a data frame including a synchronization word, a start-of-data word, and data including a carrier signal, wherein the digital optical signals are only transmitted when the carrier signal is detected; and
an optical receiver for receiving the digital optical signals and providing analog electrical signals, wherein the digital optical receiver removes the synchronization word and the start-of-data word from the data.

9. The PON of claim 8, the optical transmitter comprising:
an analog-to-digital (A/D) converter coupled to an input of the optical transmitter for converting the analog electrical signals to digital signals;
a delay circuit coupled to the A/D converter for delaying the digital signals;
a framer/encoder circuit for providing the data frame including the digital signals, the synchronization word, and the start-of-data word;
a serializer for providing a serialized data frame;
a carrier detect circuit coupled to the A/D converter for detecting the presence of the carrier signal included within the analog electrical signals;
a switching means responsive to the carrier detect circuit; and
a laser coupled to the switching means for converting the serialized data frame into the digital optical signals,
wherein the carrier detect provides the switching means with a first signal allowing the transmission of the data frame to the laser when the presence of a carrier signal is detected, and wherein the carrier detect provides the switching means a second signal that prevents the transmission of the data frame.

10. The PON of claim 9, the optical receiver comprising:
a laser detector for receiving the digital optical signals and providing electrical signals;
a serial-to-parallel circuit for providing a serial electrical signal;
a deframer/decoder circuit for removing the synchronization word and the start-of-data word from the data frame; and
a digital-to-analog (D/A) converter for converting the data frame back into the analog electrical signals.

11. The PON of claim 10, the optical receiver further comprising:
a low pass filter coupled to the D/A converter for filtering the analog electrical signals.
